(19) United States
(12) Patent Application Publication
(10) Pub. No.: US 2026/0220255 A1
(43) Pub. Date: Jul. 30, 2026

(54) ISOLATION OF FUNCTIONS WITHIN A NETWORK INTERFACE CONTROLLER

(71) Applicant: Advanced Micro Devices, Inc., Santa Clara, CA (US)

(72) Inventors: Sameer KITTUR SUBRAHMANYA, Santa Clara, CA (US); Krishna DODDAPANENI, Cupertino, CA (US); Murty Subbaramachandra KOTHA, Santa Clara, CA (US); Neel PATEL, Santa Clara, CA (US); James Bradley SMITH, Santa Clara, CA (US); Shrikant VAIDYA, Santa Clara, CA (US)

(21) Appl. No.: 19/040,708

(22) Filed: Jan. 29, 2025

(51) Int. Cl. G06F 21/55

(52) U.S. Cl. CPC G06F 21/55; G06F 2221/034

(57) ABSTRACT

A system and method mitigates unauthorized access by a network interface controller. A transaction associated with a target resource within the network interface controller is received by the network interface controller. Further, the transaction is authorized based on a characteristic of the transaction and a characteristic of the target resource within the network interface controller. The transaction is output to the target resource based on the transaction being authorized.

### TECHNICAL FIELD

Examples of the present disclosure generally relate to a network interface controller and isolating functions within the network interface controller to mitigate unauthorized access of resources of the network interface controller.

### BACKGROUND

A data center includes multiple interconnected computer systems. The computer systems of a data center communicate data with each other via network interface controllers (NICs). A NIC is a computer hardware component or circuitry that connects a computer system to a network. The NICs of the computer systems are connected to each other via the network. A NIC communicates data via a local area network and/or an internet protocol.

A NIC may include one or more processing devices that can be used to accelerate an operation of the corresponding computer system and/or data center. In one example, a NIC that includes a processing device may be referred to as a SmartNIC or a programmable NIC. A SmartNIC offloads networking functions, security functions, and/or storage functions from the corresponding computing system (e.g., host server or host device), freeing up processing power of the corresponding computer system. As a SmartNIC handles networking functions, a SmartNIC may be vulnerable to attacks from malicious users.

Thus, there is a need for an improved SmartNIC that mitigates the risk of attacks from malicious users, increasing the security of the corresponding computer system (e.g., host device).

### SUMMARY

In one example, a method includes receiving, at a network interface controller, a transaction associated with a target resource within the network interface controller. Further, the method includes authorizing, by the network interface controller, the transaction based on a characteristic of the transaction and a characteristic of the target resource within the network interface controller. The method further includes outputting the transaction to the target resource based on the transaction being authorized.

In one example, a network interface controller receives a transaction associated with a target resource within the network interface controller. Further, the network interface controller authorizes the transaction based on a characteristic of the transaction and a characteristic of the target resource within the network interface controller. The network interface controller further outputs the transaction to the target resource based on the transaction being authorized.

In one example, a computer system includes a processing device and a network interface controller coupled to the processing device and receives a transaction associated with a target resource within the network interface controller. Further, the network interface controller authorizes the transaction based on a characteristic of the transaction and a characteristic of the target resource within the network interface controller. The network interface controller output the transaction to the target resource based on the transaction being authorized.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a distributed computer system.

FIG. 2A illustrates a block diagram of a network interface controller.

FIG. 2B illustrates a simplified block diagram of a network interface controller.

FIG. 3 illustrates the flow of a transaction within a network interface controller.

FIG. 4 illustrates a flowchart of a method for authorizing a transaction within a network interface controller.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Data centers (or distributed computer systems) included multiple interconnected computer systems. A computer system may be referred to as a host device. A computer system includes one or more processing devices and memory devices, among other devices. The computer systems are interconnected via network (e.g., a wireless or wired network). The computer system further includes one or more network interface controllers (NICs) that connect the computer system to the network. A NIC functions as an input/output device transmitting and receiving (communicating) data to and from the other computer systems via the network.

A NIC includes one or more processing devices. Such a NIC may be referred to as a SmartNIC or a programmable NIC. A SmartNIC offloads one or more functions from the corresponding computer system, allowing the processing devices of the corresponding computer system to be used to complete other tasks. In one or more examples, the offloaded functions include network virtualization protocols, networking functions, security functions, and storage functions, among others.

In one or more examples, a SmartNIC provides software-defined networking (SDN) services including host facing functions including networking computing protocols, cryptographic driver protocols, and/or storage access and transport protocols, among others. Such a SmartNIC is vulnerable to attacks from malicious users to the corresponding computer system (e.g. host device or system). Attacks over a network interface may be mitigated by hardware elements (e.g., hardware circuit elements), however, attacks due software vulnerabilities are still possible. Such attacks degrade the performance of the corresponding computer systems. In one or more examples, such attacks may expose critical infrastructure details (e.g., SDN policies) and information related to the processing devices of the corresponding computer system. A compromised SmartNIC may be used to launch an attack on other infrastructure components connected to the corresponding network.

The NIC described in the following is a SmartNIC that isolates host-facing functions from other critical infrastructure functions on the NIC, mitigating attacks on the NIC and corresponding computer system. Additionally, or alternatively, the NIC described herein includes partitioned functions that mitigate attacks by preventing an unauthorized user from using compromised functions to launch other attacks on other components of the corresponding computer system. Such a NIC mitigates access by unauthorized users, improving the performance of the corresponding computer systems and mitigating disruption of workloads performed by the corresponding computer systems.

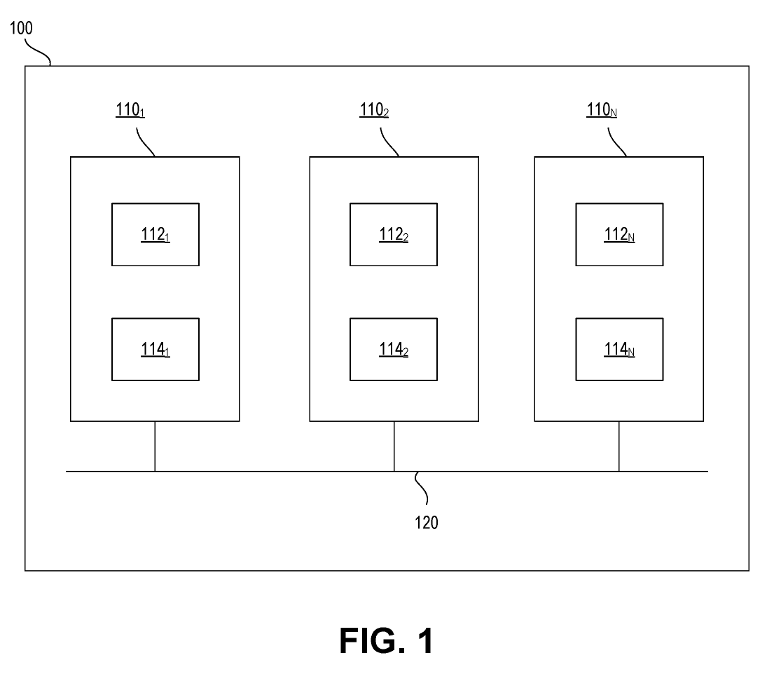

FIG. 1 illustrates a distributed computer system 100 including computer systems 110. The distributed computer system 100 may be a data center. In one or more examples, the computer systems 110 are interconnected via the network 120. The network 120 is a wired network and/or a wireless network.

The computer systems 110 include computer systems 110₁ – 110_{N}. N is one or more. The computer systems 110 may be configured similar to each other. In one or more examples, at least one of the computer systems 110 is configured differently from another one or more of the computer systems 110. In one example, a computer system includes processing device 112 and NIC 114. The processing device 112 may be a central processing unit (CPU) or a graphics processing unit (GPU), among others. In one or more examples, the processing device is a field programmable gate array (FPGA) integrated circuit (IC) device or an application specific IC (ASIC) device, among others. The processing device 112 is representative of one or more processing devices.

The NIC 114 is connected to the network 120. The NIC 114 transmits and receives data between the computer systems 110 via the network 120. In one or more examples, the NIC 114 includes one or more processing devices and is a SmartNIC or a programmable NIC. In an example where the NIC 114 includes one or more processing devices, the NIC 114 functions as an accelerator, offloading one or more functions from the processing device 112. For example, the NIC 114 may perform one or more of network virtualization protocols, networking functions, security functions, and storage functions, among others.

In one or more examples, the NIC 114 mitigates attacks from unauthorized users. The attacks may include attempts to gain unauthorized access to the NIC 114, a processing device 112, or one or more of the computer systems 110.

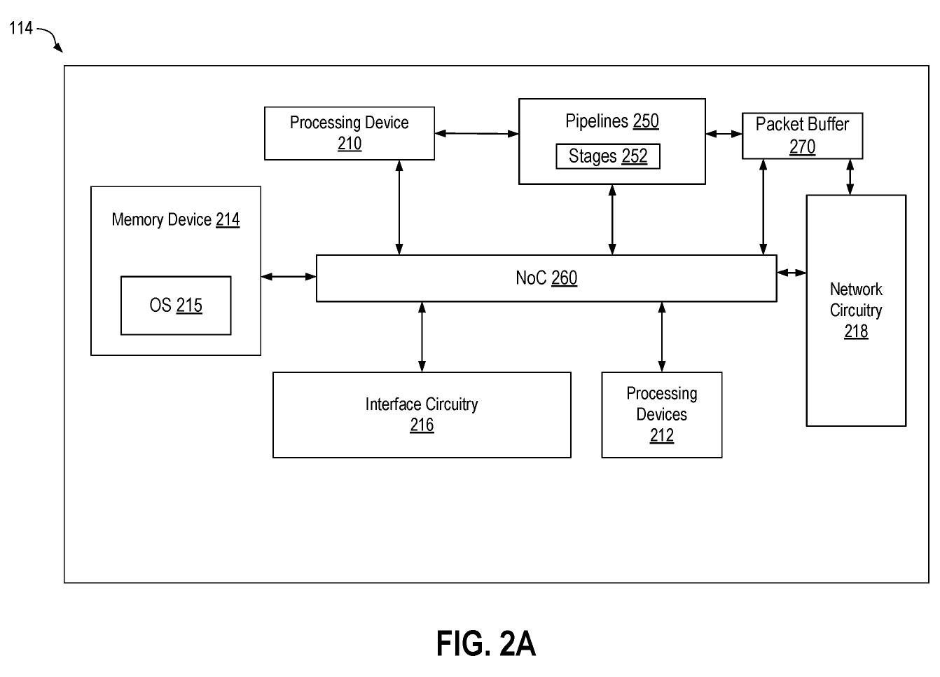

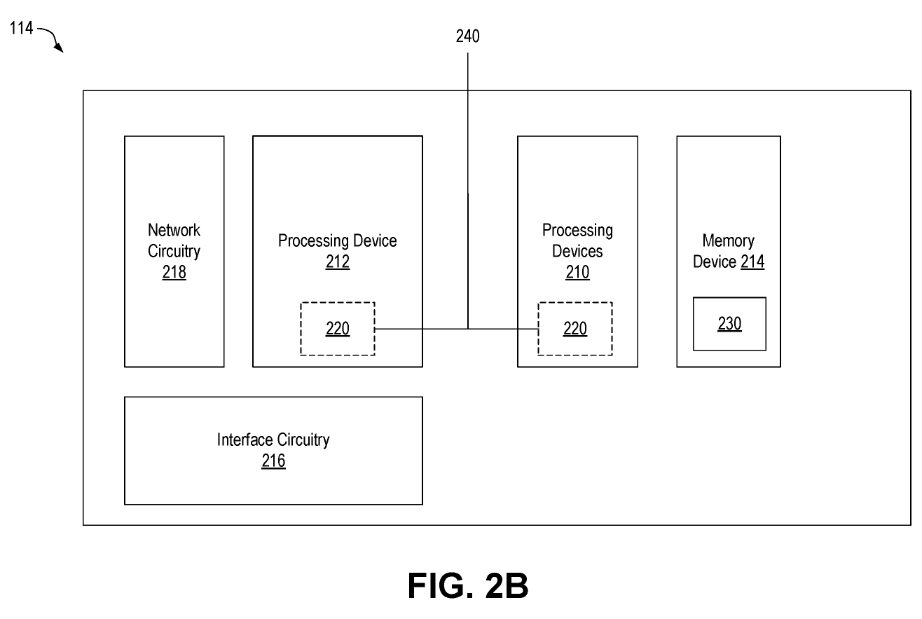

FIG. 2A illustrates an example of the NIC 114. In one example, the NIC 114 is a data processing unit (DPU). In one or more examples, the NIC 114 is a programmable processor designed to efficiently handle data-centric workloads such as data transfer, reduction, security, compression, analytics, and encryption, at scale in data centers. The NIC 114 can improve the efficiency and performance of data centers by offloading workloads from a host central processing unit (CPU) or graphic processing units (GPUs). While CPUs and GPUs can specialize on compute, the NIC 114 may specialize in data movement. The NIC 114 can communicate with host CPUs and GPUs to enhance computing power and the handling of complex data workloads.

The NIC 114 includes a plurality of processing device 210. In one example, the processing device 210 includes any number of processing cores. In one example, the processing device 210 may be one or more CPUs. The processing device 210 can form one or more CPU core complexes. The processing device 210 can be any hardware circuitry that uses an instruction set architecture (ISA) to process data, such as a complex instruction set computer (CISC) or reduced instruction set computer (RISC).

The memory device 214 can include volatile or non-volatile memory such as random access memory (RAM), high bandwidth memory (HBM), and the like. The memory device 214 can include an operating system (OS) 215 that is separate from the host OS.

In one example, the NIC 114 may (or be used to implement) a SmartNIC that processes packets before they are forwarded to a host (e.g., a host CPU or GPU). In one example, the NIC 114 is a fully programmable P4 DPUs. The NIC 114 includes multiple pipelines 250 (which can be the same type or different types) for processing received network packets stored in a packet buffer 270. In this example, the pipelines 250 have direct connections to the packet buffer 270.

The pipelines 250 can operate in parallel. Further, the pipelines 250 can be the same type of pipeline (e.g., perform the same tasks). In other embodiments, the NIC 114 may have different types of pipelines 250. For example, the NIC 114 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 250 include multiple stages 252 where received packet data is processed at each stage 252 before being passed to the next stage. This packet data could be the entire packet or just a portion of the packet. For example, a parser in the DPU 600, which is upstream from the pipelines 250, may parse out a particular portion of a received packet (e.g., a packet header vector (PHV)) which is then sent to the one of the pipelines 250.

The stages 252 can include circuitry or hardware. In one example, the stages 252 can be programmed using a pipeline programming language, such as P4. In one example, the stages 252 in one pipeline 250 perform the same functions of the stages 252 in another pipeline 250. However, in other embodiments, the stages may perform different functions.

In addition to the stages, the pipelines 250 may each include memory, which can be referred to as local memory. This memory can store local tables that indicate how, or if, a particular packet should be processed at the stages 252. For example, one of the stages in the pipelines 250 can perform a lookup to read a policing entry in a table to determine whether an entity associated with the packet has exceeded a rate limit (e.g., a packet rate limit, a data rate limit, or both).

The NIC 114 can include processing devices 212. In one or more examples, the processing devices 212 are accelerators that perform specialized tasks associated with data movement. The processing devices 212 can include a cryptography accelerator, a data compression accelerator, as well as accelerators for performing regex or dedupe. In other examples, the processing devices 212 may be other types of processing devices. In one example, the processing device 212 is a programmable processing device. For example, the processing device 212 is an FPGA IC device. The processing device 212 may be representative of one or more processing devices.

To communicate with the host and a network, the NIC 114 includes interface circuitry 216 and network circuitry 218. The interface circuitry 216 is a parallel or serial interface. The network circuitry 218 can include a PCIe interface, or any suitable protocol for communicating with a CPU or GPU in the host. The network circuitry 218 can include Ethernet interfaces, and the like for communicating with a network. The network circuitry 218 is a transceiver that communicates over a network (e.g., the network 120 of FIG. 1). In one example, the network circuitry 218 provides a Gigabit or greater connection.

The NIC 114 includes a network on chip (NoC) 260 for interconnecting the various components discussed above. While a NoC is disclosed, the NIC 114 can include any suitable on-chip network. While some components in the NIC 114 may rely on the NoC 260 to communicate with other components, the NIC 114 can also include connections between components that bypass the NoC 260. For example, the packet buffer 270 can have a connection to the network circuitry 218 that bypasses the NoC 260. Similarly, the pipelines 250 can exchange packet data with the packet buffer 270 without having to rely on the NoC 260. However, to transfer data to the processing device 210, the pipelines 250 may use the NoC 260.

In one example, the NIC 114 includes security and management features such as offering a hardware root of trust, secure boot, and the like.

FIG. 2B illustrates an example simplified block diagram of the NIC 114. The processing devices 212 include one or more processing devices.

In one or more examples, the NIC 114 performs isolation to prevent unauthorized access to one or more elements within the NIC 114 (e.g., the processing device 210, the processing devices 212, the memory device 214, the interface circuitry 216, and/or the network circuitry 218, among others) or an element connected to the NIC 114 (e.g., the processing device 112 of a corresponding computer system 110 and/or to another computer system 110). In one example, the NIC 114 is partitioned to form two or more different subsets of functions. The subsets of functions are isolated from each other. The isolation may be a software isolation and/or a hardware isolation. In one example, isolating functions from each other (e.g., isolating subsets of functions) prevents unauthorized access and/or interaction between the functions. In one example, host facing functions are isolated from infrastructure functions of the NIC 114. Host facing functions are associated with a corresponding processing device 112 and/or other elements of a corresponding computer system 110). For example, the host facing functions may include the communication of data within the computer system 110. In one example, the host facing functions include communicating data via the interface circuitry 216. In one or more examples, host-facing functions may include aspects such as exposing a network, storage and/or cryptographic offload devices to a corresponding computer system 110 and/or processing device 112. The infrastructure functions are within the corresponding NIC 114. For example, infrastructure functions may include functions used to communicate between the elements of the NIC 114 (e.g., the processing device 210, the processing devices 212, the memory device 214, the interface circuitry 216, and/or the network circuitry 218, among others). In one or more examples, infrastructure functions are higher privileged functions. For example, infrastructure functions may include software defined network (SDN) policies and corresponding packet forwarding functions. The infrastructure functions may include data encryption, data compression, and communication with storage devices (or services) external to the corresponding computer system 110. In one or more examples, infrastructure functions may include a communication endpoint for the corresponding computer system 110, agents for infrastructure services including provisioning, monitoring, and configuration of the computer system 110. In one or more examples, the communication between host facing functions and the infrastructure components is via a packet-based interface(s) and/or a packet interface based remote procedure call (RPC). Accordingly, by isolating the different subsets of functions from each other, if one of the subsets is compromised (e.g., access via an authorized user or agent), the functions of another subset are not accessible and access to the functions of another subset is mitigated. Accordingly, mitigation of authorized access within the computer system is increased, improving the security of the corresponding computer system.

In one example, host functions are restricted from accessing one or more portions of the memory device 214. Memory filters 220 may be used by the processing device 210 to restrict access to one or more portions of the memory device 214. In one example, the processing device 210 executes instructions stored in the memory device 214 or instructions stored within a memory device of the processing device 212 to perform the functions of the memory filters 220. In one or more examples, the memory filters 220 are executed within the circuitry of the processing device 212. For example, the memory filters 220 include circuitry elements of the processing device 212. In one example, the processing device 212 includes programmable circuitry. In such an example, at least a portion of the programmable circuitry of the processing device 212 is programmed (or configured in some other way) to perform the functions of the memory filters 220.

The memory filters 220 ensure that first functions (functions of a first subset) are restricted from accessing second functions (functions of a second subset). In one example, the first functions are host-facing functions and the second functions are infrastructure functions or other functions of the NIC 114. In one or more examples, the first functions are restricted (or prevented) from injecting code into the second functions (e.g., memory associated with the second functions) and/or corrupting the portions of memory associated with the second functions.

The memory filters 220 are programmable. For example, the memory filters 220 are programmable to configure the memory filters 220 with how to direct transactions received from a host device (e.g., the processing device 112 of FIG. 1) or another computer system 110. For example, the programming the memory filters 220 can determine which transactions are provided access to which functions (e.g., portions of the memory device 214).

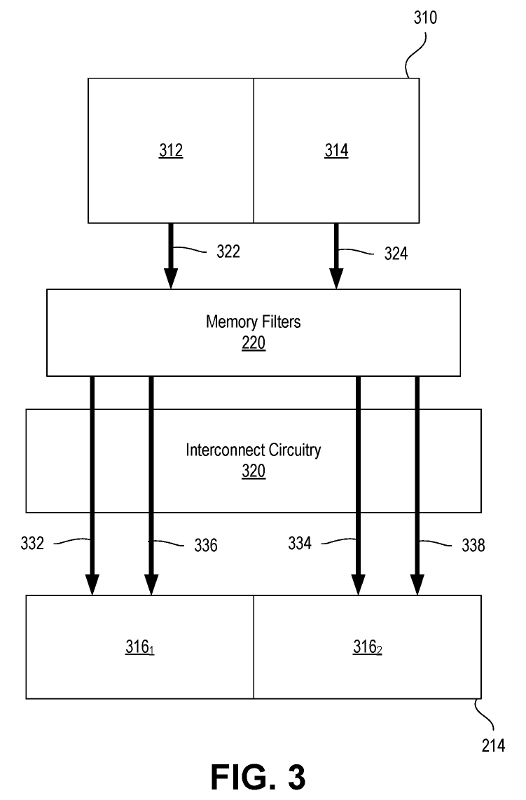

As is illustrated in FIG. 3, the memory filters 220 receive transactions 322 and 324 from a master device 310. The master device 310 may be a processing device (e.g., a processing device 112). The transactions 322 are associated with a host NIC context 312 and the transactions 324 are associated with a NIC context 314. In one or more example, the host NIC context 312 corresponds to transactions that include the transmission of signals (e.g., data and/or control signals) between the NIC 114 and a host device (e.g., the processing device 112). The NIC context 314 corresponds to transactions that include the transmission of signals (e.g., data and/or controls signals) within the NIC 114.

The memory filters 220 are connected to the memory device 214 via the interconnect circuitry 320. The interconnect circuitry 320 includes one or more communication buses and/or other connections within the corresponding NIC 114.

In one example, the memory filters 220 determine whether or not to allow a transaction 322, 324 access to the memory device 214 based on characteristics of the transaction. For example, a transaction is allowed or denied based on an address of the transactions. In one example, the transactions 322 are transactions associated with the host NIC context 312. The transactions 322 include transactions 332 and 336. The memory device 214 includes a first portion 316₁and a second portion 316₂. In other examples, the memory device 214 may include more than two portions. In one example, the first portion 316₁is associated with host NIC functions and the second portion 316₂is associated with NIC functions.

The memory filters 220 receive the transactions 322 determines the target address (e.g., address within the memory device 214). Based on the target address of the transactions, the memory filters 220 allow or deny a transaction. For example, the transactions 322 include the transactions 332 and 334. The transaction 332 has a target address associated with the memory portion 316₁and the transaction 334 has a target address associated with the memory portion 362₂. As the transaction 332 is a host NIC transaction and has a target address associated with the memory portion 316₁, which is a host NIC function memory portion, the transaction 332 is allowed by the memory filters 220. As the transaction 334 is a host NIC transaction and has a target address associated with the memory portion 316₂, which is a NIC function memory portion, the transaction 334 is denied by the memory filters 220.

The transactions 324 include the transactions 336 and 338. The transaction 336 has a target address associated with the memory portion 316₁and the transaction 338 has a target address associated with the memory portion 362₂. The transaction 336 is a NIC transaction and has a target address associated with the memory portion 316₁, which is a host NIC function memory portion. Accordingly, the transaction 332 is denied by the memory filters 220. The transaction 338 is a NIC transaction and has a target address associated with the memory portion 316₂, which is a NIC function memory portion. Accordingly, the transaction 338 is allowed by the memory filters 220.

An allowed transaction is able to access the target memory portion and perform the corresponding operations. A denied transaction is not able to access the target memory portion and is not able to perform the corresponding operations.

While the above examples are described with regard to using target memory addresses, in other examples, other characteristics of the transaction may be used by the memory filters 220 to deny or allow the corresponding transaction.

In one example, the memory filters 220 are programmed based on the characteristics that are used to deny or allow transactions. For example, the memory filters 220 are programmed with the address space for each memory portion (e.g., the memory portions 316₁ and 316₂) of the memory device 214. In one or more examples, the memory filters 220 compare the target address of a transaction with the characteristic or characteristics for each memory portion to determine to deny or allow a transaction. In one or more examples, programming the memory filters 220 is a privileged operation. A privileged operation is accessible by a processing device (e.g., the processing device 112) or another element of the corresponding computer system (e.g., the computer system 110) that belongs to the privileged domain. A processing device (or other element of the corresponding computer system) that does not belong to the privileged domain is blocked from programming and/or updating a memory filter 220. In one example, the memory filters 220 include an indication as to which devices have privileged access and/or belong to the privileged domain. The memory filters 220 determine whether or not a device is able to program and/or update the memory filters 220 based on a comparison of the device to those that have privilege access and/or belong to the privileged domain.

In one example, processor exception level-based isolation processes are used to provide different privilege levels to different software processes 230. The software processes (or threads) 230 include code or instructions stored within the memory device 214 that is executed by the processing device 210 and/or the processing devices 212 to perform the software processes 230. In one example, the processing device 210 and/or the processing devices 212 determines whether or not to allow the software processes 230 to access different privilege levels. In one example, a software process 230 makes a request from a lower privilege level to a higher privilege level. The request is an exception that is treated as a system call by the processing device 210 and/or the processing devices 212. In one example, the processing devices 212 (and/or the processing device 210) determine whether to validate and grant the call or to deny the call.

In one example, a privileged bit of one or more of the processing devices 212 (and/or the processing device 210) is turned on or turned off depending on the current exception level of an executed software process 230. In one example, when the privilege access is turned on, unrestricted access is provided to the resources. Unprivileged access provides limited access to a subset of the resources. In one or more example, an entity (e.g., software processes or resources) that has a higher privilege access is able to access resources having a lower privilege access. In one example, resources in higher privilege levels are protected from lower privilege levels by layers of abstraction within the processing device or devices. In one or more examples, access to the network circuitry 218, the interface circuitry 216, and/or regions within the memory device 214 is limited based on privilege levels.

For examples, access to the network circuitry 218, the interface circuitry 216, and/or regions within the memory device 214 may be at a higher privilege level. In one example, when a software process having a lower privilege level attempts to access a resource having a higher privilege level, an exception is generated, blocking the access to the resource having the higher privilege level.

In other examples, more than two privilege levels may be used. In one or more examples, four or more privilege levels are used. In such examples, access to resources at higher privilege levels is limited for entities that have a lower privilege level.

In one or more examples, privilege levels may be used to restrict (limit) access to one or more portions of the memory device 214 and/or memory elements (e.g., registers) within a processing device (e.g., the processing device 210 or processing devices 212). Further, using privilege levels allows for software processes (e.g., one or more of the software processes 230) to be secure software processes that run at elevated (e.g., higher) privilege. Such secure software processes have limited access and unauthorized access to the secure software processes is mitigated through the use of privilege as described above.

In one or more examples, the memory filters 220 are used to determine whether or not a transaction can be permitted access to a resource based on the privilege levels of the transaction and corresponding resource. The memory filters 220 deny access when the transaction has a privilege level that lower than the privilege level of the requested resource. The memory filters 220 permits (grants) access when the transaction has a privilege level that lower than the privilege level of the requested resource.

With further reference to FIG. 2B, the memory filters 220 are accessed via the interface 240. The interface 240 may be referred to as an out-of-band interface. In one example, the interface 240 is accessed by a processing device 112 of a corresponding computer system 110, or another element of the computer system 110. In one example, the memory filters 220 are updated via the interface 240. For example, the memory filters 220 are updated with the addresses of the memory portions 316₁– 316₂of the memory device 214. The memory filters 220 are updated with the access permission (e.g., permission information) for each of the memory portions 316₁– 316₂. For example, the memory filters 220 are updated with which of the memory portions 316₁– 316₂has an access permission associated with a host NIC context, and which of the memory portions 316₁– 316₂ has an access permission associated with a NIC context. In one or more examples, the memory filters are updated with the privilege levels of the resources within the NIC 114 and/or the privilege levels of the memory portions 316₁– 316₂of the memory device 214. In one or more examples, the interface 240 may be used to update the software processes 230. For example, privilege levels of the software processes 230 may be set or updated via the interface 240. In one example, to perform an updated via the interface 240 an authorization value, or values, is provided to the element to be updated (e.g., the memory filters 220 and/or the software processes 230). The element to be updated validates the authorization value, or values, and performs the update request. In one example, the authorization value, or values, may be provided by associated with a lower privilege transaction to request access to a higher privilege resource. The authorization value, or values, may be one-time authorization value, or values. In other examples, other types of authorization value, or values, may be used.

The interface 240 provides a secure method to update the memory filters 220 and/or the software processes 230 as the interface 240 is not accessible by processing device 210, the processing devices 212, and/or other elements within the NIC 114. In one example, the interface 240 terminates via a physical connector within the corresponding computer system 110. Remote access to the interface 240 may be provided via a dedicated (isolate) network infrastructure, limiting access to the interface 240. As remote access to the interface 240 is provided via a dedicated network infrastructure, unauthorized user access is mitigated. Accordingly, the security of the interface 240 and the NIC 114 is increased.

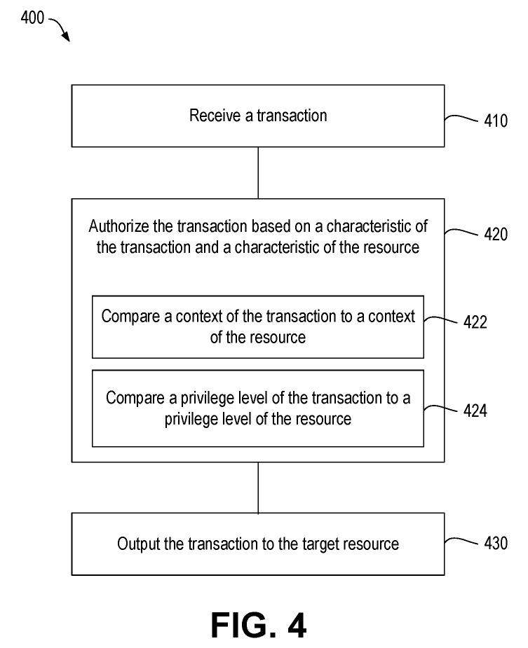

FIG. 4 illustrates a flowchart of a method 400 for granting access to a transaction by a NIC (e.g., a NIC 114 of FIG. 1). In one example, the method 400 is performed by the NIC 114₁of FIG. 1. At operation 410 of the method 400, a transaction is received. The transaction is received by the NIC 114₁. The transaction is received from the computer system 110₁that includes the NIC 114₁. In one example, the transaction is received from the processing device 112₁of the computer system 110₁. In another example, the transaction is received from the computer system 110₂or 110_{N} via the network 120. A transaction received from outside the NIC 114₁may be referred to a host NIC context transaction. In one example, the transaction is received from within the NIC 114₁. The transaction may include a request to access a resource of the NIC 114₁. A transaction received from within the NIC 114₁may be referred to a NIC context transaction. For example, the transaction may include a request to access the processing device 210, the one or more of the processing devices 212, the memory device 214, the interface circuitry 216, and/or the network circuitry 218.

At operation 420 of the method 400, the transaction is authorized based on a characteristic of the transaction and a characteristic of a target resource. In one example, the NIC 114₁compares the characteristic of the transaction to the characteristic of the target resource to determine whether or not to authorize the transaction. In one example, authorizing the transaction includes allowing the resource to access the target resource. Not authorizing the transaction includes denying the resource to access the target resource. The target resource may include the processing device 210, the one or more of the processing devices 212, the memory device 214, the interface circuitry 216, and/or the network circuitry 218.

In one example, the operation 420 of the method 400 includes operation 422, comparing a context of the transaction to a context of the resource. In one example, the memory filters 220 receive the transaction and determine whether or not to authorize the transaction. In one example, the transaction is a request to access (e.g., read data from and/or write data to) the memory device 214. In such an example, the memory filters 220 determine a target address of the transaction. The memory filters 220 determine whether or not the transaction of is able to access the target address within the memory devices 214 based on permissions (e.g., permissions information) of the different portions of the memory devices 214. For example, the memory device 214 includes memory portions 316₁and 316₂. Each portion 316₁ and 316₂corresponds to a range of addresses within the memory device 214. Further, each portion 316₁and 316₂is associated with a different permission. For example, the portion 316₁is associated with host NIC context permissions and the portion 316₂is associated with NIC context permissions. In one example, the memory filters 220 determines that the transaction is a host NIC context transaction as the transaction is received from the processing device 112₁, another element within the computer system 110₁, or another computer system 110 via the network 120. The memory filters 220 determine that the target address is within the memory portion 316₁that is associated with host NIC context permissions. Accordingly, the memory filters 220 authorize the transaction.

In an example where the transaction is determined to have a permission that differs from the target resource, the transaction is denied. For example, the transaction may be determined to have a NIC context permission that differs from the permission (e.g., host NIC context) of the memory portion 316₁. Accordingly, the transaction is denied.

In one example, the operation 420 of the method 400 includes operation 424, comparing a privilege level of the transaction to a privilege level of the resource. In one or more examples, a characteristic of a transaction corresponds to a privilege level for the transaction. The privilege level of the transaction is compared to the privilege level for the target resource. When the privilege level of the transaction is greater than or equal to the privilege level of the target resource, access to the resource by the transaction is authorized. In one example, a processing device (e.g., the processing device 210 or a processing device 212) receives the transaction. The processing device determines the privilege level of the transaction and the privilege level of the target resource. The processing device authorizes (allows) the transaction to access the target resource based on the privilege level of the transaction being greater than or equal to the privilege level of the target resource. For example, the processing device allows a transaction to access the interface circuitry 216 based on the privilege level of the transaction being greater than or equal to the privilege level of the interface circuitry 216.

At the operation 430 of the method 400, the transaction is output to the target resource. The transaction is output based on the transaction being authorized at 420 of the method 400. In one example, the target resource is a memory portion 316₁or 316₂, the interface circuitry 216, or the network circuitry 218. The transaction is output to the target resource and the operations of the transaction are executed by the target resource. In one example, the memory filters 220 output the transaction to the target resource. In another example, a processing device (e.g., the processing device 210 or the processing device 212) output the transaction. In one example, outputting the transaction includes allowing a transaction to be communicated to the target resource. In another example, outputting the transaction includes providing the transaction to the target resource.

The NIC described in the above is a SmartNIC that isolates host-facing functions from other critical infrastructure functions on the NIC, mitigating attacks on the NIC and corresponding computer system. The NIC described includes partitioned functions that mitigate unauthorized access by mitigating unauthorized access to resources within the NIC based on corresponding permissions. Mitigating access by unauthorized users improves the performance of the corresponding computer systems and mitigates disruption of workloads performed by the corresponding computer systems.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving, at a network interface controller, a transaction associated with a target resource within the network interface controller;
authorizing, by the network interface controller, the transaction based on a characteristic of the transaction and a characteristic of the target resource within the network interface controller; and
outputting the transaction to the target resource based on the transaction being authorized.

2. The method of claim 1, wherein authorizing the transaction based on the characteristic of the transaction and the characteristic of the target resource comprises comparing the characteristic of the transaction with the characteristic of the target resource.

3. The method of claim 1, wherein the target resource is a first portion of a memory device of the network interface controller, and the characteristic of the transaction corresponds to a first context permission and the characteristic of the target resource corresponds to a second context permission, and wherein authorizing the transaction comprises determining the first context permission corresponds to the second context permission.

4. The method of claim 3, wherein the transaction is authorized by memory filters of the network interface controller.

5. The method of claim 4 further comprising updating, via a host device connected to an interface of the network interface controller, the memory filters.

6. The method of claim 1, wherein the characteristic of the transaction corresponds to a first privilege level and the characteristic of the target resource corresponds to a second privilege level.

7. The method of claim 6, wherein authorizing the transaction comprises determining that the first privilege level is higher than or equal to the second privilege level.

8. A network interface controller configured to:
receive a transaction associated with a target resource within the network interface controller;
authorize the transaction based on a characteristic of the transaction and a characteristic of the target resource within the network interface controller; and
output the transaction to the target resource based on the transaction being authorized.

9. The network interface controller of claim 8, wherein authorizing the transaction based on the characteristic of the transaction and the characteristic of the target resource comprises comparing the characteristic of the transaction with the characteristic of the target resource.

10. The network interface controller of claim 8, wherein the target resource is a first portion of a memory device of the network interface controller, and the characteristic of the transaction corresponds to a first context permission and the characteristic of the target resource corresponds to a second context permission, and wherein authorizing the transaction comprises determining the first context permission corresponds to the second context permission.

11. The network interface controller of claim 10 comprising memory filters, and wherein the transaction is received by and authorized by the memory filters.

12. The network interface controller of claim 11, wherein the memory filters are configured to be updated via a host device connected to an interface of the network interface controller.

13. The network interface controller of claim 8, wherein the characteristic of the transaction corresponds to a first privilege level and the characteristic of the target resource corresponds to a second privilege level.

14. The network interface controller of claim 13, wherein authorizing the transaction comprises determining that the first privilege level is higher than or equal to the second privilege level.

15. A computer system comprising:
a processing device; and
a network interface controller coupled to the processing device and configured to:
receive a transaction associated with a target resource within the network interface controller;
authorize the transaction based on a characteristic of the transaction and a characteristic of the target resource within the network interface controller; and
output the transaction to the target resource based on the transaction being authorized.

16. The computer system of claim 15, wherein the target resource is a first portion of a memory device of the network interface controller, and the characteristic of the transaction corresponds to a first context permission and the characteristic of the target resource corresponds to a second context permission, and wherein authorizing the transaction comprises determining the first context permission corresponds to the second context permission.

17. The computer system of claim 16 comprising memory filters, and wherein the transaction is received by and authorized by the memory filters.

18. The computer system of claim 17, wherein the memory filters are configured to be updated via a host device connected to an interface of the network interface controller.

19. The computer system of claim 15, wherein the characteristic of the transaction corresponds to a first privilege level and the characteristic of the target resource corresponds to a second privilege level.

20. The computer system of claim 19, wherein authorizing the transaction comprises determining that the first privilege level is higher than or equal to the second privilege level.
